(19) United States
(12) Patent Application Publication
(10) Pub. No.: US 2016/0210047 A1
(43) Pub. Date: Jul. 21, 2016

(54) DATA LIBRARY SYSTEM

(71) Applicant: Hitachi-LG Data Storage, Inc., Tokyo (JP)

(72) Inventors: Masayuki KOBAYASHI, Tokyo (JP); Hirofumi TSUJIMURA, Tokyo (JP)

(21) Appl. No.: 14/972,414

(22) Filed: Dec. 17, 2015

(30) Foreign Application Priority Data
Jan. 21, 2015 (JP) 2015-009064

(51) Int. Cl. G06F 3/06

(52) U.S. Cl. CPC G06F 3/061; G06F 3/0604; G06F 3/0647; G06F 3/0683

(57) ABSTRACT

A data transfer task which corresponds to each recording medium and transfers data from the first recording apparatus to the second recording apparatus is operated on a controller, and the number of the data transfer tasks operating in parallel is limited when the data stored in the first recording apparatus is transferred to the second recording apparatus.

### INCORPORATION BY REFERENCE

The present application claims priority from Japanese application JP-2015-009064 filed on Jan. 21, 2015, the content of which is hereby incorporated by reference into this application.

### BACKGROUND OF THE INVENTION

The present invention relates to a data library system. As the related art of this field of the invention, JP-A-2005-100264 discloses “attempting the reduction of a necessary data transfer bandwidth without impairing the real time performance”.

### SUMMARY OF THE INVENTION

In JP-A-2005-100264, there is provided an invention that keeps the peak value of a necessary bus bandwidth low by preventing at least two upper processing execution periods of large necessary bus bandwidths from overlapping at the same time.

By the way, there is a data library system that transmits saved data to a data library apparatus after saving the data on a hard disk once, and records it in multiple recording reproducing apparatuses in the data library apparatus.

The recording performance of the above-mentioned data library system is decided by the slower one of the data reproduction speed from a hard disk (hereinafter referred to as “hard disk transfer speed”) and the total recording speed of a data recording reproducing apparatus in a data library apparatus (hereafter referred to as “data library apparatus recording speed”) when data stored in the hard disk is recorded in the data library apparatus. Therefore, for the recording performance to be required, a hard disk with sufficient transfer speed and a data library apparatus with sufficient recording speed have to be formed in the system.

Therefore, when the technique of JP-A-2005-100264 is applied to the above-mentioned data library system to control the transfer capability of the above-mentioned hard disk and realize processing by a more low-priced hard disk, there is the following problem.

When data recorded in multiple recording reproducing apparatuses in a data library apparatus are read from a hard disk in the same execution period, a random IO request is generated in the hard disk, and the transfer speed decreases more than sequential IO.

In a case where data to be recorded in each recording reproducing apparatus in the data library apparatus is small and discretely disposed in the hard disk, the transfer speed of the hard disk may rather decrease by limiting processing to be executed in the same period.

Therefore, it is an object of the present invention to provide a data library system and data library apparatus that can achieve the optimization of the data transfer of a hard disk in the above-mentioned data library system and data library apparatus and perform recording with necessary recording performance by the use of a low-priced hard disk configuration.

To solve the above-mentioned problems, for example, the configurations described in the claims are adopted.

According to the present invention, it is possible to provide a data library system that can perform recording with necessary recording performance by the use of a low-priced hard disk configuration.

Other problems, configurations and effects than the above are clarified by description of the following embodiments.

### BRIEF DESCRIPTION OF THE DRAWINGS

FIG. 1 is a block diagram illustrating the configuration of a data library apparatus in a data library system;

FIG. 2A is an outline drawing (front view) of a data library apparatus;

FIG. 2B is an outline drawing (side view) of the data library apparatus;

FIG. 3 is a block diagram illustrating the configuration of a server in a data library system;

FIG. 4A is a block diagram illustrating the configuration of a data recording reproducing apparatus.

FIG. 4B is a block diagram illustrating the configuration of a signal processing circuit in the data recording reproducing apparatus;

FIG. 5 is a block diagram illustrating the configuration of an optical disc transportation apparatus;

FIG. 6 is an outline drawing of an optical disc transportation apparatus;

FIG. 7 is a flowchart of data recording of a data library system;

FIG. 8 is a detailed flowchart of data recording into an optical disc;

FIG. 9 is a flowchart of file data recording in Embodiment 1;

FIG. 10 illustrates one Embodiment of a management table of an optical disc;

FIG. 11 illustrates one Embodiment of a management table of division data;

FIG. 12 is a flowchart of file data recording in Embodiment 2;

FIG. 13 is a state transition diagram showing whether it is possible to limit the number of recording tasks;

FIG. 14 is a flowchart of file data recording in Embodiment 3;

FIG. 15 is a flow of post processing in Embodiment 3; and

FIG. 16 is a flow of wait processing in Embodiment 3.

### DESCRIPTION OF THE EMBODIMENTS

### Embodiment 1

In the following, Embodiments are described using drawings.

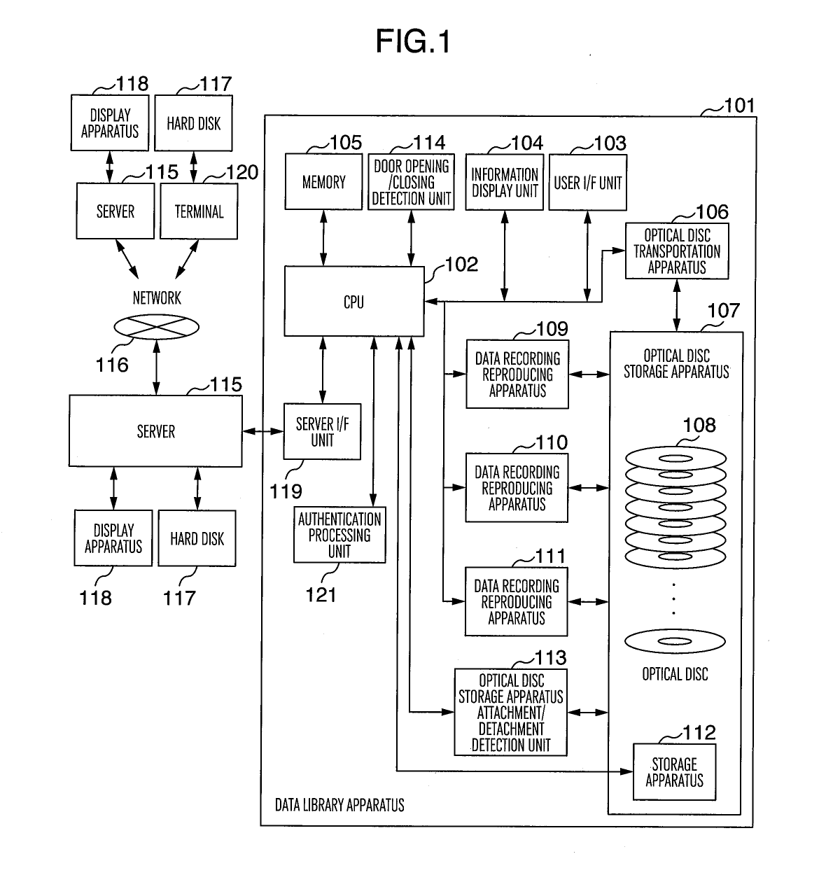

FIG. 1 is a block diagram illustrating the configuration of a data library system.

In this system, one or more servers 115 and terminals 120 are connected by network 116 such as a wireless/wired LAN (Local Area Network), a WAN (Wide Area Network) or an optic cable.

Hard disk 117, display apparatus 118 and data library apparatus 101 are connected with above-mentioned server 115. Multiple hard disks 117 and multiple data library apparatuses 101 may be connected.

Data library apparatus 101 includes CPU (Central Processing Unit) 102, user I/F unit 103, information display unit 104, memory 105, optical disc transportation apparatus 106, optical disc storage apparatus 107, one or more optical discs 108, one or more data recording reproducing apparatuses (three of 109, 110 and 111 in FIG. 1), storage apparatus 112, optical disc storage apparatus attachment/detachment detection unit 113, door opening/closing detection unit 114, server I/F unit 119 and authentication processing unit 121. At the time of recording, data library apparatus 101 receives a data recording instruction from server 115, receives data and records the received data in optical discs 108. At the time of reproduction, the data is reproduced from optical discs 108, and the data is passed to server 115.

By a request from server 115, CPU 102 controls optical disc transportation apparatus 106, selects a desired optical disc from multiple optical discs 108 stored in optical disc storage apparatuses 107, and sends it to data recording reproducing apparatuses 109, 110 and 111. Moreover, it controls optical disc transportation apparatus 106, receives an optical disc from data recording reproducing apparatuses 109, 110 and 111, and stores the optical disc in predetermined positions in optical disc storage apparatuses 107. Moreover, in addition to the reading and writing of information in recording reproducing apparatuses 109, 110 and 111, it acquires information detected by optical disc storage apparatus attachment/detachment detection unit 113 and door opening/closing detection unit 114, and performs control based on the acquired information. Moreover, authentication processing unit 121 performs control to perform authentication in accordance with a specific authentication protocol through server I/F unit 119, such that server 115 determines whether data library apparatus 101 is a regularly recognized apparatus, or server 115 confirms that both of them are mutually valid apparatuses.

User I/F unit 103 provides means for operating the data library apparatus by the user, such as various switches. Information display unit 104 outputs various kinds of information such as the operation state of the data library apparatus to an internal or external liquid crystal display or an LED (Light Emitting Diode). Memory 105 stores various kinds of programs and information, for example, memory 105 also stores a program and setting information to control CPU 102 of the data library apparatus.

Optical disc transportation apparatus 106 is controlled by CPU 102 of the data library apparatus, removes optical discs 108 from optical disc storage apparatuses 107, transports them and loads them to data recording reproducing apparatuses 109, 110 and 111. Alternatively, it receives optical discs 108 from data recording reproducing apparatuses 109, 110 and 111, transports them and stores them in optical disc storage apparatuses 107.

Optical disc storage apparatuses 107 include multiple optical discs 108. Moreover, optical disc storage apparatuses 107 can be attached and detached. For example, when data has been recorded in all optical discs, it is removed to the outside of the data library apparatus one optical disc storage apparatus at a time, and another optical disc storage apparatus that stores an unrecorded disc instead can be entered in the data library apparatus, and so on.

Here, only one optical disc storage apparatus 107 is illustrated in FIG. 1, but two or more ones may be included in the library apparatus. Moreover, for example, they may be separately used according to the use such that one is an unrecorded disc storage apparatus and the other is a recorded disc storage apparatus, and they may be separately used according to a disc type such that one is a single-sided recordable disc and the other is a double-sided recordable disc. Naturally, the insides of optical disc storage apparatuses 107 may be divided into an unrecorded disc storage region and a recorded disc storage region.

Multiple optical discs 108 are stored in the insides of respective optical disc storage apparatuses 107. At the time of data recording, the optical discs are removed from optical disc storage apparatuses 107 by optical disc transportation apparatus 106 and loaded to data recording reproducing apparatuses 109, 110 and 111, and, when data recording ends, they are returned to optical disc storage apparatuses 107 by optical disc transportation apparatus 106. Meanwhile, at the time of data reproduction, optical discs 108 are removed from optical disc storage apparatuses 107 by optical disc transportation apparatus 106 and loaded to data recording reproducing apparatuses 109, 110 and 111, and, when data is reproduced and data reproduction ends, they are returned to optical disc storage apparatuses 107 by optical disc transportation apparatus 106.

Data recording reproducing apparatuses 109, 110 and 111 are controlled by CPU 102 of the data library apparatus and performs recording of data in optical discs 108 or performs reproduction of data from optical discs 108. Moreover, the data recording reproducing apparatus can be attached and detached, and, for example, when a failure or the like occurs, it is possible to detach it from the data library apparatus and install an alternative data recording reproducing apparatus in the data library apparatus, and so on. Here, the data library apparatus mounts three data recording reproducing apparatuses in FIG. 1, but the mounting number is not limited, and, for example, it may mount six data recording reproducing apparatuses.

Recording reproducing apparatuses 109, 110 and 111 store information on an optical disc storage apparatus and information required to control the optical disc storage apparatus, beforehand. Optical disc storage apparatus attachment/detachment detection unit 113 detects the attachment/detachment of optical disc storage apparatuses 107, and transmits detected information to CPU 102. Door opening/closing detection unit 114 detects the opening/closing of a door held by the data library apparatus, and transmits detected information to CPU 102.

Server I/F unit 119 transmits and receives data to be recorded/reproduced and various kinds of control commands and notice between server 115 and data library apparatus 101. Authentication processing unit 121 performs authentication in accordance with a specific authentication protocol through server I/F unit 119, such that server 115 determines whether data library apparatus 101 is a regularly recognized apparatus, or server 115 confirms that both of them are mutually valid apparatuses. This authentication processing is implemented at an arbitrary timing such as timing when data library apparatus 101 is connected with server 115 or system setting timing by the user. Moreover, a specific key may be shared when authentication succeeds, and a control command and data exchanged between server 115 and data library apparatus 101 may be encoded/decoded using the key directly or indirectly. Here, the key may be set to server I/F unit 119, and the control command and the data may be encoded/decoded by above-mentioned server I/F unit 119.

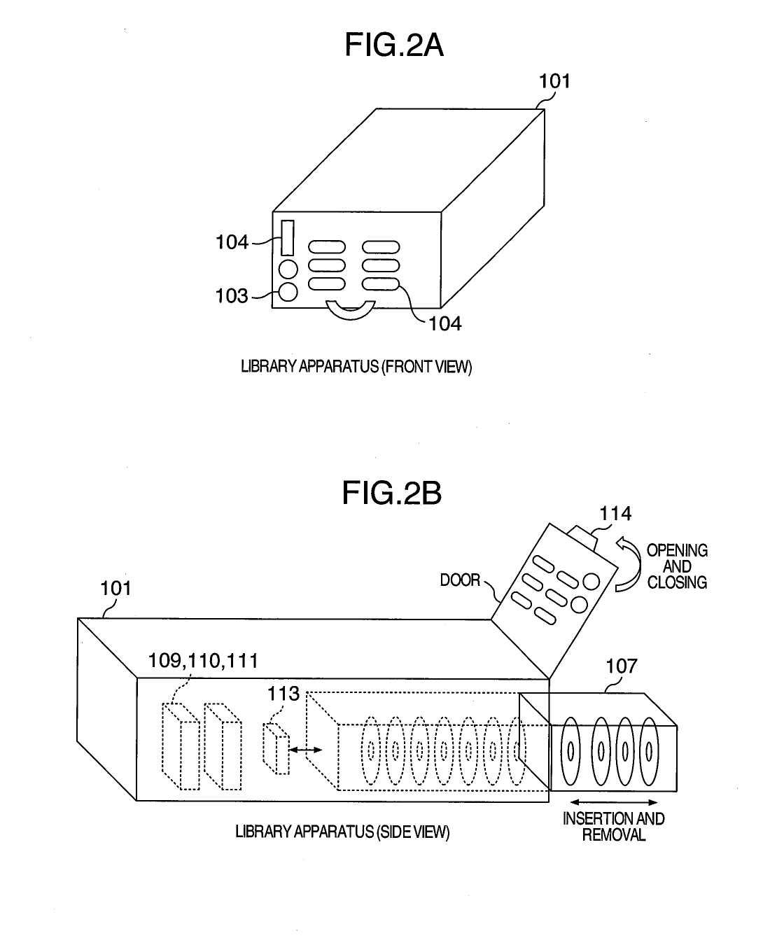

The outline drawing of a data library apparatus is illustrated in FIGS. 2A and 2B. FIG. 2A is a front view and FIG. 2B is a side view.

Server 115 causes the data library apparatus to perform data recording/reproducing control by communication with CPU 102 of data library apparatus 101, and performs data management through hard disk 117, information display through display apparatus 118 and transmission/reception control of data and information with other devices connected through network 116. “116” indicates a network, and multiple servers and data library apparatuses, and so on, are connected. “117” indicates a hard disk, and data and information related to the control of the data library system are accumulated. Hard disk 117 is formed with one or more hard disk drives that records and reproduces data in a hard disk, and it may be formed with multiple hard disk drives and one or more RAID groups that perform distribution recording reproduction for multiple hard disk drives. In this specification, a set of multiple hard disk drives and a set of RAID groups are also described as hard disk 117.

“118” indicates a display apparatus, and information on a server or a data library apparatus and hard disk connected with the server is displayed. “119” indicates a server interface unit, and performs control related to data transmission/reception between CPU 102 of the data library apparatus and CPU 301 of server 115.

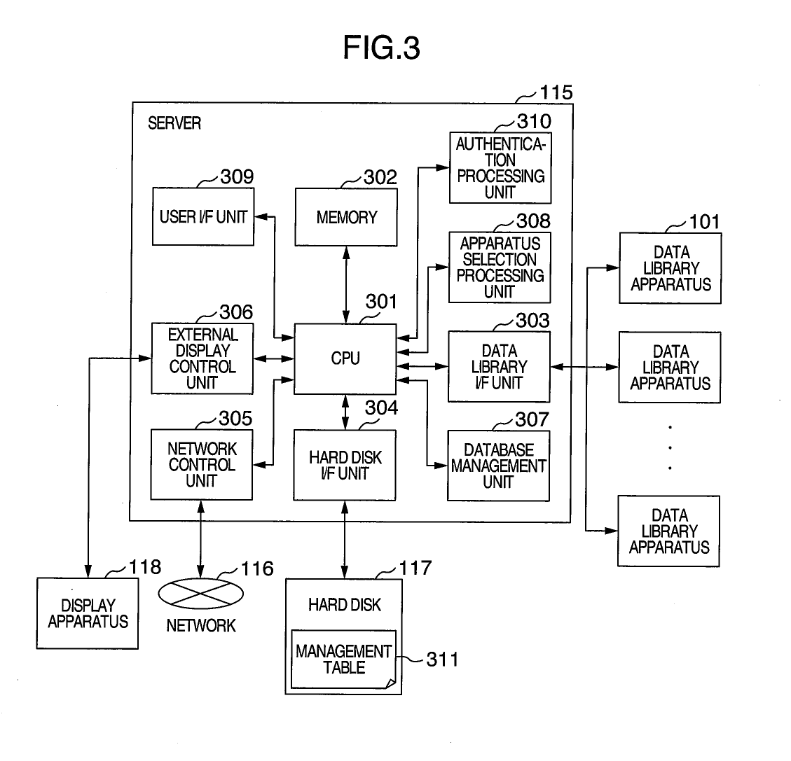

FIG. 3 is a block diagram illustrating the configuration of a server in a data library system. Server 115 is formed by connecting to one or more data library apparatuses 101, network 116, hard disk 117 and display apparatus 118. Server 115 is formed with CPU 301, memory 302, data library I/F unit 303, hard disk I/F unit 304, network control unit 305, external display control unit 306, database management unit 307, apparatus selection processing unit 308, user I/F unit 309 and authentication processing unit 310.

At the time of data recording, CPU 301 records data, which is received from network 116 through network control unit 305, in hard disk 117 through hard disk interface unit 304. Alternatively, it controls data library apparatus 101 through data library interface unit 303 and performs recording in optical disc 108 built in data library apparatus 101.

Or, CPU 301 temporarily records the data, which is received from network 116 through network control unit 305, in hard disk 117 through hard disk interface unit 304, reads the temporarily recorded data from hard disk 117 through the hard disk interface unit, controls data library apparatus 101 through data library interface unit 303, and performs recording in optical disc 108 built in data library apparatus 101.

At the time of data reproduction, CPU 301 reads the data from hard disk 117 through hard disk interface unit 304 and transmits the read data to network 116 through network control unit 305. Alternatively, it controls the data library apparatus through data library interface unit 303, reproduces data from the optical disc built in the data library apparatus, receives the reproduced data and transmits the received data to network 116 through network control unit 305.

Or, CPU 301 controls the data library apparatus through data library interface unit 303, reproduces data from the optical disc built in the data library apparatus, receives the reproduced data, temporarily records the received data in hard disk 117 through hard disk interface unit 304, reads the temporarily recorded data from hard disk 117 through hard disk interface unit 304 and transmits the read data to network 116 through network control unit 305.

Moreover, it arbitrarily processes various kinds of information received from the data library apparatus, records and manages it or reproduces the information, decides a control policy on the basis of the reproduced information and performs actual control. Furthermore, it displays the information on display apparatus 118 through external display control unit 306.

Moreover, to determine whether connected data library apparatus 101 is a regularly recognized apparatus or to confirm that another server 115 connected through network 116 are mutually valid apparatuses, CPU 301 controls authentication processing unit 310 to perform authentication in accordance with a specific authentication protocol through data library I/F unit 303 or network control unit 305.

Memory 302 records a program to control CPU 301 of server 115, and various kinds of information. Moreover, it records thermal information and vibration information in the data library apparatus, which are transmitted from data library apparatus 101, and, moreover, characteristic information on each data recording reproducing apparatus built in the data library apparatus.

Data library I/F unit 303 performs control related to data transmission/reception between data library apparatus 101 and CPU 301 of server 115. Here, multiple data library apparatuses are connected with one data library interface unit in the figure, but, for example, a configuration in which multiple data library apparatuses are connected through a network is also possible.

Hard disk I/F unit 304 performs data transfer with hard disk 117 in accordance with a standard such as SATA (Serial Advanced Technology Attachment). Network control unit 305 performs control related to data transmission/reception between network 116 and CPU 301 of server 115.

Database management unit 307 rules access to a database that records various kinds of information to be used to control the data library system. Specifically, it performs processing such as information registration in the database or the reading and search of registered information. Here, database management unit 307 of this Embodiment determines as to whether it is necessary to newly create or update a database to control a system, or determines as to which information is registered in the database, and it is assumed to entrust an essential operation or management of the database to CPU 301. However, it is not limited thereto, and the essential operation or management of the database may be managed in database management unit 307. Here, the database is stored in memory 302 or hard disk 117.

When performing the recording or reproduction of data, apparatus selection processing unit 308 determines or selects which of one or more data library apparatuses connected to the server is used, determines or selects which of one or more data recording reproducing apparatuses built in the above-mentioned selected data library apparatus is used, and, moreover, selects an optical disc in which recording and reproduction are performed, and so on.

User I/F unit 309 provides means for causing a user to control the server on the basis of various kinds of information displayed on display apparatus 118 and control each data library apparatus through the server. To determine whether connected data library apparatus 101 is a regularly recognized apparatus or to confirm that another server 115 connected through network 116 are mutually valid apparatuses, authentication processing unit 310 performs authentication in accordance with a specific authentication protocol through data library I/F unit 303 or network control unit 305. It is assumed that an authentication protocol used with data library apparatus 101 and an authentication protocol used with another server 115 are different. Moreover, in a case where the above-mentioned authentication succeeds, a specific key is shared and the key is directly or indirectly used to encode/decode a control command or data exchanged with data library apparatus 101 or another server 115. Here, the above-mentioned key may be set to data library I/F unit 303 or network control unit 305, and the control command and the data may be encoded/decoded by data library I/F unit 303 or network control unit 305. Management table 311 is a table of a database that exists in hard disk 117 and memory 302, and it is managed by database management unit 307. The number of the above-mentioned tables is not limited to one, and the data library system of this Embodiment manages a necessary number of tables.

Multiple data library apparatuses 101 are connected with server 115 in FIG. 3, but multiple data library apparatuses 101 may be collected in one chassis.

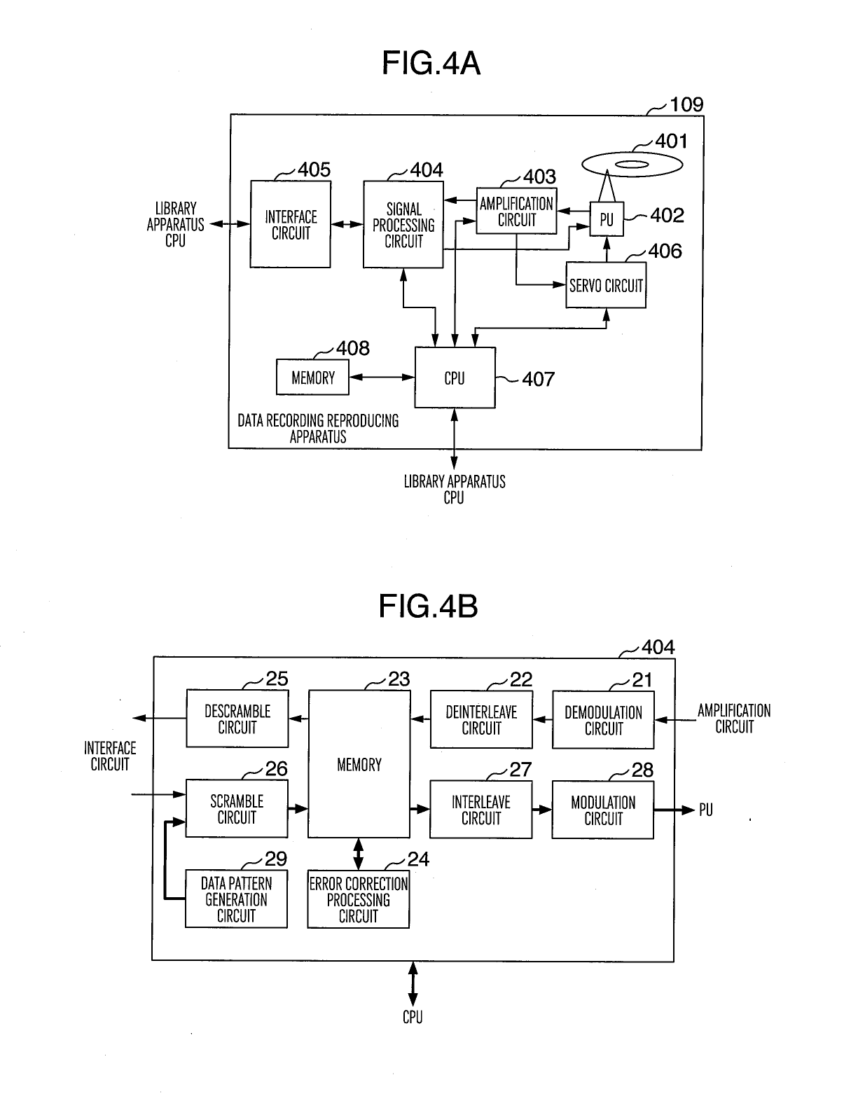

FIGS. 4A and 4B are block diagrams illustrating the configuration of data recording reproducing apparatus 109.

Data recording reproducing apparatus 109 includes removable optical disc 401, optical pickup 402, amplification circuit 403, signal processing circuit 404, interface circuit 405, servo circuit 406, CPU 407 and memory 408. CPU 407 controls recording processing and reproduction processing of data recording reproducing apparatus 109. Here, instead of the CPU, an arbitrary circuit that can perform similar control may be used. Moreover, when starting the recording processing or reproduction processing of the data recording reproducing apparatus, it starts the collection of load information on each block managed by itself and when ending the recording processing or reproduction processing, it records the collected information in the memory and outputs the recorded information to CPU 102 of the library apparatus. “401” indicates a data recording medium, for example, a BD-R (Blu-ray (registered trademark) Disc Recordable) or a BD-RE (Blu-ray (registered trademark) Disc Rewritable). Moreover, in the following explanation, it is merely described as optical disc 401. Furthermore, the data recording medium is not necessarily limited to the optical disc, and it may be recording media such as a magneto-optical disc and a hologram.

Optical pickup 402 reads a signal from optical disc 401 and sends it to amplification circuit 403. Moreover, it records a modulation signal sent from signal processing circuit 404 in optical disc 401. Amplification circuit 403 amplifies a reproduction signal, which is read from optical disc 401 through optical pickup 402, and sends it to signal processing circuit 404. Moreover, it generates a servo signal and sends it to servo circuit 406.

Signal processing circuit 404 demodulates the input signal and sends data subjected to error correction or the like to interface circuit 405. Moreover, it adds an error correcting code to data sent from interface circuit 405, and so on, and modulates and sends it to optical pickup 402. Interface circuit 405 performs data transfer processing in accordance with SATA and other transmission modes, for example. At the time of data transfer, it sends the data, which is sent from signal processing circuit 404, to the CPU of the library apparatus which is a host. Moreover, it sends the data, which is sent from the CPU of the library apparatus which is a host, to signal processing circuit 404.

Servo circuit 406 controls optical pickup 402 by the servo signal generated by amplification circuit 403. “408” indicates a memory and stores programs and various kinds of setting information to control the data recording reproducing apparatus, and medium information acquired from the optical disc, and so on. Here, an Embodiment where memory 408 is connected with CPU 407 in the data recording reproducing apparatus has been shown, but it may be connected with any part inside or outside the data recording reproducing apparatus. Moreover, it may not be a memory as long as it can hold information, for example, it may be a hard disk.

Signal processing circuit 404 of this Embodiment includes data demodulation circuit 21, deinterleave circuit 22, memory 23, error correction processing circuit 24, descramble circuit 25, scramble circuit 26, interleave circuit 27, data modulation circuit 28 and data pattern generation circuit 29. Data demodulation circuit 21 performs 17PP (Parity Preserve/Prohibit RMTR) demodulation on an input signal from amplification circuit 403 and sends the result to deinterleave circuit 22. Deinterleave circuit 22 releases the interleaved data sent from data demodulation circuit 21 and writes the result in memory 23. Memory 23 is used as a memory for error correction, an error correcting code addition memory and a buffer memory. Memory 23 is mounted with SRAM and DRAM, and so on, but it may be replaced with a memory circuit having other similar functions.

Error correction processing circuit 24 reads data from memory 23, performs error correction and writes the result in memory 23. Moreover, it generates an error correcting code with respect to the data read from memory 23 and writes it in memory 23. Descramble circuit 25 releases the scrambled data for which the error correction is completed, and sends the result to interface circuit 405.

Scramble circuit 26 applies scramble to data input from interface circuit 405 or data pattern generation circuit 29, and writes the result in memory 23. Interleave circuit 27 interleaves the data read from memory 23 and sends the result to data modulation circuit 28. Data modulation circuit 28 performs 17PP modulation on the data sent from interleave circuit 27 and sends the result to the optical pickup.

Data pattern generation circuit 29 switches and sends multiple data patterns, which are transmitted from CPU 301 of data library apparatus 101 through data library I/F unit 303 and received through interface circuit 405, or multiple data patterns for overwrite erasure, to scramble circuit 26. Here, data pattern generation circuit 29 may not be an independent circuit but may be included in scramble circuit 26 or the like.

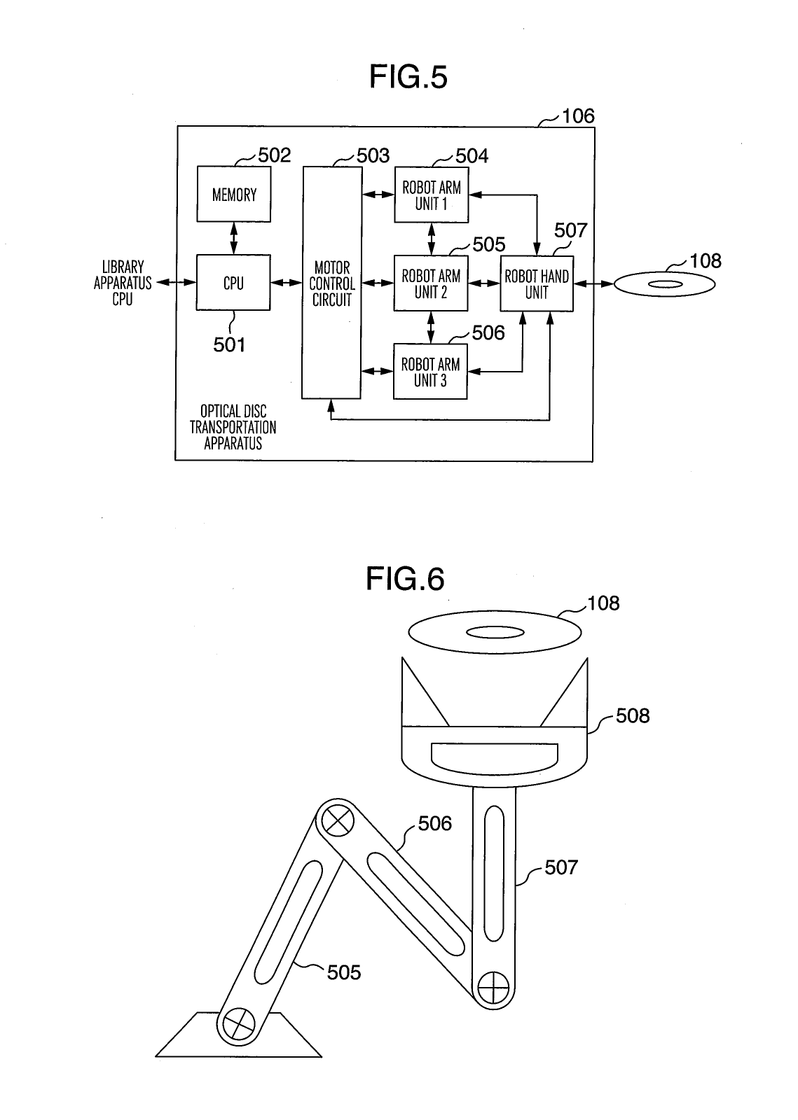

FIG. 5 is a block diagram of optical disc transportation apparatus 106, and FIG. 6 is an outline drawing of optical disc transportation apparatus 106.

Optical disc transportation apparatus 106 includes CPU 501, memory 502, motor control circuit 503, robot arm units 504, 505 and 506, and robot hand unit 507.

CPU 501 controls optical disc transportation apparatus 106. Memory 502 stores programs and various kinds of setting information, and so on, to control optical disc transportation apparatus 106. Moreover, it is used as a region to record collected thermal information and vibration information. Here, an Embodiment where memory 502 is connected with CPU 501 in the optical disc transportation apparatus has been shown, but it may be connected with any part inside or outside the optical disc transportation apparatus. Moreover, it may not be a memory as long as it can hold information, for example, it may be a hard disk.

Motor control circuit 503 drives the robot arm units of 504, 505 and 506 on the basis of an instruction from CPU 501. Moreover, it derives robot hand unit 507. Robot arm units 504, 505 and 506 adjust the position of robot hand unit 507 by linear movement and rotary movement like a forward movement and a backward movement. Robot hand unit 507 is formed in a shape that can hold optical discs 108 without damaging them, and loads/unloads and passes the optical discs to optical disc storage apparatuses 107 and data recording reproducing apparatuses 109, 110 and 111.

The optical disc transportation apparatus of the above-mentioned configuration transports the optical discs between the optical disc storage apparatuses and the data recording reproducing apparatuses according to an instruction from the CPU of the data library apparatus.

Here, an Embodiment where one optical disc transportation apparatus exists in the data library apparatus has been shown, but multiple optical disc transportation apparatuses may exist. Moreover, the shape of the optical disc transportation apparatus is not limited to the example of FIG. 6, and, for example, it may be the one that fixes and transports an optical disc by using the core hole of the optical disc, and the one that takes out an optical disc from an optical disc storage apparatus by pushing it, stores the taken optical disc in a chassis for transportation, and transports the optical disc together with the chassis.

In this Embodiment, explanation is given by exemplifying a data library system using an optical disc as a recording medium. It is known that the optical disc is more suitable for long preservation than other media and is excellent in the point of data protection at the time of disaster. However, the scope of the present invention is not limited to this, and, for example, a magnetic tape or the like may be used as recording medium.

Moreover, it is assumed that multiple optical discs are stored in an optical disc storage apparatus and the exchange of optical discs is implemented for each optical disc storage apparatus. Since the data library system treats a very large amount of data and the number of optical discs for recording is large, if optical discs unloaded from the data library system (hereinafter referred to as “offline disc”) are managed one by one, the management costs become very high. Therefore, by performing offline management in units of optical disc storage apparatuses collecting multiple optical discs, the reduction in the management costs becomes possible.

Moreover, in a case where exchange is implemented for each optical disc storage apparatus in this way, to reduce the exchange frequency of optical disc storage apparatuses, it is useful to decide a user and the type of data to be stored, and so on, for each optical disc storage apparatus, and record data having a high possibility of reproduction at a time in the same optical disc storage apparatus. In the reproduction of an off-line disc, by recording data having a high possibility of reproduction at a time in the same optical disc storage apparatus, it becomes possible to reduce the frequency of exchange operation, shorten the time up to the reproduction of desired data and reduce costs caused by the exchange operation. In this Embodiment, a user and the type of data, which are set for each optical disc storage apparatus, are assumed as a group, and management is performed by group ID. That is, in a case where the same user uses multiple optical disc storage apparatuses or data of the same type is recorded therein, the same group ID is set to the multiple optical disc storage apparatuses. Moreover, this group ID is also set to all data stored in a data library apparatus and used for the selection of an optical disc at the time of data recording, and so on.

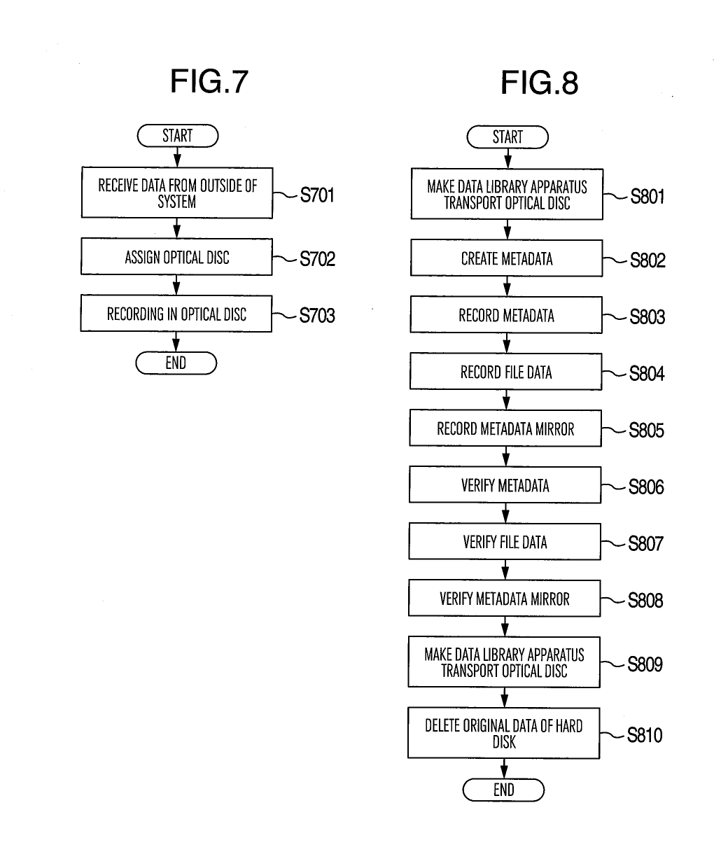

FIG. 7 is a flowchart of data recording of the data library system of this Embodiment. The data recording of the above-mentioned data library system shows operation that, from server 115 and terminal 120 of another system outside the system, server 115 of the system receives data together with a recording request through network 116 and records them in hard disk 117 and optical disc 108 of the system.

S701 indicates operation to receive data from the outside of the system, where the transmission source is server 115 or terminal 120 of another system connected with the system of this Embodiment through network 116 and server 115 of the system of this Embodiment receives data together with a record request. The above-mentioned record request is, for example, a file creation and file writing request of a network file system (NFS). The received data is recorded in hard disk 117.

Moreover, for example, in the case of NFS, the record request includes the file name, the directory path name, access authority information, the owner identifier, the belonging group identifier, time information, the file identifier, file capacity information, data offset information or information on other data. NFS has been described as one example in the above, but other protocols are also possible.

S702 indicates operation to assign an optical disc, where database management unit 307 of server 115 accesses management table 311 in hard disk 117 or memory 302 and assigns the data received in S701 to the specific optical disc 108.

In the above-mentioned assignment processing, a volume table is created for each optical disc 108 in management table 311, and the above-mentioned data is added to the volume table. The above-mentioned volume table includes the ID or the like showing assigned optical disc 108 as the table name, and the table internally includes the data name, the data size, data date information, data access authority information, and, if the data is in a file format, the file name and path information, and so on, as the record of each data.

S703 indicates operation to record the above-mentioned data in the optical disc, where server 115 transfers the above-mentioned data recorded in hard disk 117 to data library apparatus 101 to record it in optical disc 108.

FIG. 8 is an operation flow showing the details of record S703 in an optical disc.

S801 indicates processing to transport an optical disc to the data library apparatus, where server 115 gives a transportation request to data library apparatus 101 so as to transport optical disc 108 that records data, from optical disc storage apparatus 107 to what is made to perform recording among data recording reproducing apparatuses 109, 110 and 111. Data library apparatus 101 having received the above-mentioned transportation request transports optical disc 108 that records data, from optical disc storage apparatus 107 to what is made to perform recording among data recording reproducing apparatuses 109, 110 and 111.

S802 indicates processing to create metadata, where server 115 creates metadata of a file system such as a UDF (Universal Disc Format) and metadata of the backup of the database of a data library system, and so on, and preserves them in hard disk 117.

S803 indicates processing to record metadata, where server 115 transmits a recording request and the metadata to data library apparatus 101 so as to read the metadata created in S802 from hard disk 117 and record it in optical disc 108 transported by the processing in S801.

S804 indicates processing to record file data, where server 115 transmits a recording request and the metadata to data library apparatus 101 so as to read file data, which is received by server 115 from terminal 120 or the like via network 116, from hard disk 117, and record it in optical disc 108 transported by the processing in S801.

S805 indicates processing to record a metadata mirror. Server 115 transmits a recording request and the metadata to data library apparatus 101 so as to read the metadata created in S802 from hard disk 117 and record it in optical disc 108 transported by the processing in S801.

S806 indicates processing to verify the metadata. Server 115 transmits a verification request to data library apparatus 101 so as to simultaneously read the metadata created in S802 from hard disk 117 and verify it from optical disc 108 transported by the processing in S801, data library apparatus 101 simultaneously reads the metadata from optical disc 108 and verifies the recording quality of a region in which the metadata of the optical disc is recorded, and transmits the metadata read from optical disc 108 in server 115 to server 115, and server 115 compares the metadata read from hard disk 117 and the metadata read from optical disc 108 in units of bytes.

S807 indicates processing to record file data. Server 115 transmits a verification request to data library apparatus 101 so as to simultaneously read the file data, which is received by server 115 from terminal 120 or the like via network 116 from hard disk 117, and verify it from optical disc 108 transported by the processing in S801, data library apparatus 101 simultaneously reads the file data from optical disc 108 and verifies the recording quality of a region in which the file data of the optical disc is recorded, and transmits the file data read from optical disc 108 in server 115 to server 115, and server 115 compares the file data read from hard disk 117 and the file data read from optical disc 108 in units of bytes.

S808 indicates processing to verify a metadata mirror. Server 115 transmits a verification request to data library apparatus 101 so as to simultaneously read the metadata created in S802 from hard disk 117 and verify it from optical disc 108 transported by the processing in S801. Data library apparatus 101 simultaneously reads the metadata from optical disc 108 and verifies the recording quality of the region in which the metadata of the optical disc is recorded, and transmits the metadata read from optical disc 108 in server 115 to server 115, and server 115 compares the metadata read from hard disk 117 and the metadata read from optical disc 108 in units of bytes.

S809 indicates processing to transport an optical disc to the data library apparatus. Server 115 outputs a transportation request to data library apparatus 101 so as to transport optical disc 108 that records data to optical disc storage apparatus 107 from what is made to perform recording among data recording reproducing apparatuses 109, 110 and 111. Data library apparatus 101 having received the above-mentioned transportation request transports optical disc 108 that records the data to optical disc storage apparatus 107 from what is made to perform recording among data recording reproducing apparatuses 109, 110 and 111.

The recording flow illustrated in FIG. 7 operates on a recording task that operates on server 115. Multiple pieces of the recording tasks can operate at the same time, and it is possible to perform operation by the recording tasks for data recording reproducing apparatuses built in data library apparatus 101 connected with server 115.

According to FIG. 7, server 115 assigns data received from the outside of a system to optical disc 108 one by one, receives the above-mentioned multiple items of data, and, after assigning the above-mentioned data only for the capacity of optical disc 108 or the upper limit file number, performs assignment for next optical disc 108. For example, the above-mentioned data is received in a file format. In the case of reception in the file format, for example, server 115 performs exchange with the outside of the system by the CIFS or NFS protocol.

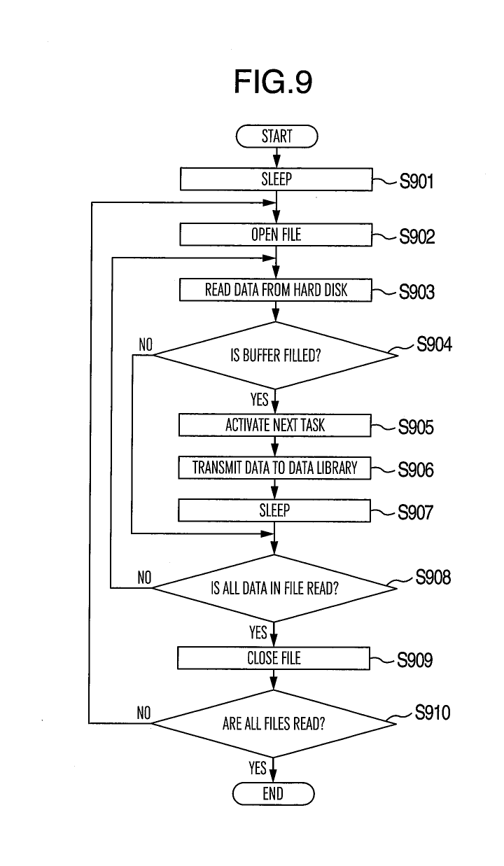

FIG. 9 indicates a detailed processing flow of processing S804 that records file data. S901 indicates processing in which other tasks except one task sleep when multiple tasks operate until the S905 processing to activate other tasks from other tasks is performed in a case where other tasks are operating, and a recording task itself sleeps to interrupt processing. When the number of operating tasks is one, it does not sleep. S902 indicates processing to open a file, and server 115 opens the files assigned to optical disc 108 in which its own task performs recording, in file data received from terminal 120 or the like via network 116. In S902, data information is obtained with reference to the above-mentioned volume table. In a case where the data is not in a file format, preparation processing to read the data from hard disk 117 is performed.

S903 indicates processing to read data from the hard disk, where server 115 reads the file data opened in S902 from hard disk 117. The capacity of the read data corresponds to the reading for less capacity of the remaining capacity in which reading processing of the above-mentioned files is not performed and the remaining capacity of a buffer on memory 302 prepared for each recording task.

S904 indicates processing to determine whether the buffer is filled. It is determined whether the above-mentioned buffer on server 115 is filled, it proceeds to S905 in a case where the buffer is filled, and it proceeds to S908 in a case where the buffer is not filled. S905 indicates processing to activate the next task, where a task of the next order among other sleeping recording tasks is activated. For example, the above-mentioned order is managed by queue, they are arranged in order of sleeping and processed by FIFO (First In First Out) in which they are selected as a activated task in order from the first recording task. In a case where a sleep flag in memory 302 is FALSE, all of other sleeping recording tasks are activated. In a case where there are no other recording tasks in the above-mentioned queue, other recording tasks are not activated.

S906 indicates processing to transmit data to a data library. It is processing in which server 115 transmits the data, which is read from hard disk 117 in S903 and stored in the above-mentioned buffer, to data library apparatus 101. For example, the data transmission is performed by socket communication.

S907 indicates processing to sleep. The recording task itself sleeps and interrupts processing. When sleeping, it adds its own recording task ID to the above-mentioned queue. In a case where the above-mentioned sleep flag is FALSE, it does not sleep. In a case where there are no other recording tasks in the above-mentioned queue, it does not sleep.

By performing processing S905 to activate the next task and processing S907 to sleep and switching an operating task from a task that operates up to S905 to the task activated in S905, the number of tasks that concurrently perform processing S903 to read data from the hard disk is limited.

S908 indicates processing to determine whether all data in a file is read. It proceeds to S909 in a case where all data of the data in the files opened in S902 is read in S903, and it proceeds to S902 in a case where there is the remaining data capacity that is not read in S903.

A909 is a processing to close the files opened in S902. S910 indicates determination processing to determine whether all files are read. The processing ends in a case where all files have been read, and it returns to S902 in a case where there remains a file that has not been read yet.

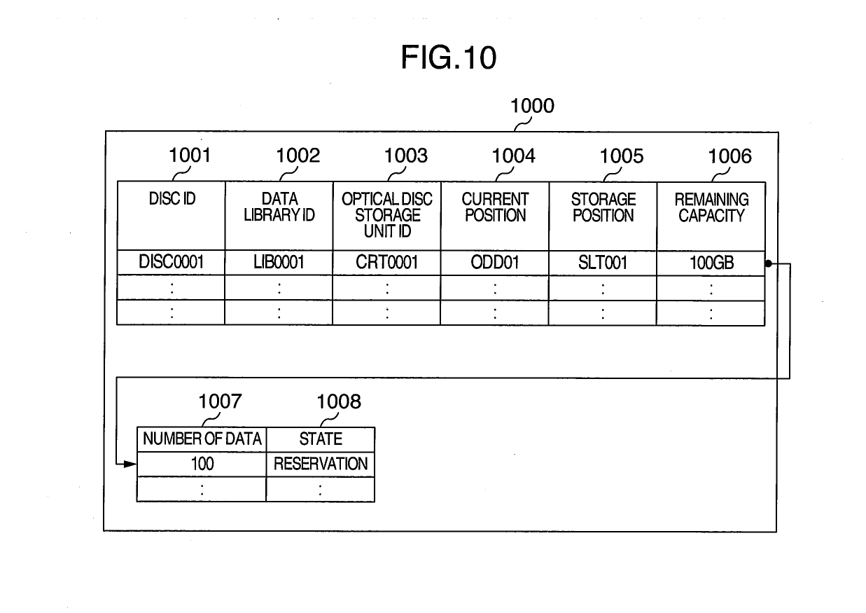

FIG. 10 indicates disc table 1000, which is one of management tables 311 and is a table that manages optical disc 108 in data library apparatus 101. Disc table 1000 is a database table which stores information of disc ID 1001, data library ID 1002, optical disc storage unit ID 1003, current position 1004, storage position 1005, remaining capacity 1006 data number 1007 and state 1008 for each optical disc 108.

In above-mentioned table 1000, when an optical disc storage apparatus is connected with the data library system of this Embodiment for the first time or when it is connected again after being connected to another data library system once, information on optical disc 108 stored in the optical disc storage apparatus is registered and updated. Moreover, it is also updated when optical disc 108 is moved between the data recording reproducing apparatuses 109 to 111 and optical disc storage apparatus 107 or when the remaining capacity 1006, data number 1007 or state 1008 of optical disc 108 changes.

“1001” indicates the disc ID, which is a character string or numeral to identify optical discs 108 one by one. The above-mentioned ID is an ID which can identify an individual recorded at the time of the manufacture of optical disc 108 as it is, is generated based on it or is an ID which is uniquely decided by the data library system of this Embodiment.

“1002” indicates the data library ID, which is an ID to identify data library apparatus 101. In disc table 1000, the data library ID of data library apparatus 101 in which there is optical disc 108 of the same row is recorded.

“1003” indicates the optical disc storage unit ID, which is a character string or numeral that identifies optical disc storage apparatus 107. The above-mentioned ID is determined and recorded in storage apparatus 112 attached to optical disc storage apparatus 107 when optical disc storage apparatus 107 is manufactured or before shipped. When the above-mentioned ID is registered or updated in the database table, CPU 102 reads the above-mentioned ID from storage apparatus 112.

“1004” indicates the current position, where the data recording reproducing apparatuses 109 to 111 in a position in which optical disc 108 of the same row is currently present or a character or numeral that is an address in optical disc storage apparatus 107 is recorded.

“1005” indicates a storage position, where a character string or numeral that is an address in optical disc storage apparatus 107 in which optical disc 108 of the same row has to be stored is recorded. The above-mentioned storage position is a position in optical disc storage apparatus 107 stored when optical disc 108 is shipped.

By storing a specific position as a storage position, even if server 115 and data library apparatus 101 become a cutting state by a power failure or a network failure and data library apparatus 101 is in a state where it is not possible to notify position information on optical disc 108 to server 115, if data library apparatus 101 returns a currently transported optical disc 108 to the original position to prevent the damage of the apparatus, server 115 does not miss optical disc 108.

A position stored at the time of shipping is assumed as storage position 1005 in the above, but, in a case where the abandonment of an optical disc or a change in storage position 1005 is instructed from terminal 120 or the like as a user request, storage position 1005 is changed from the position stored at the time of shipping. Moreover, since arrangement is performed according to the frequency of transportation request of optical disc 108, the storage position 1005 might be changed.

“1006” indicates the remaining capacity, where a numerical value subtracting only the total capacity of data assigned to optical disc 108 of the same row from the full capacity of optical disc 108 is recorded. Here, the above-mentioned assignment does not correspond to capacity in a case where data is physically recorded in optical disc 108, and denotes processing to virtually perform assignment before the recording of data physically begins. However, the assignment processing can be changed between the one with physical recording processing and processing to perform virtual assignment, and is defined to one of them in advance by the data library system.

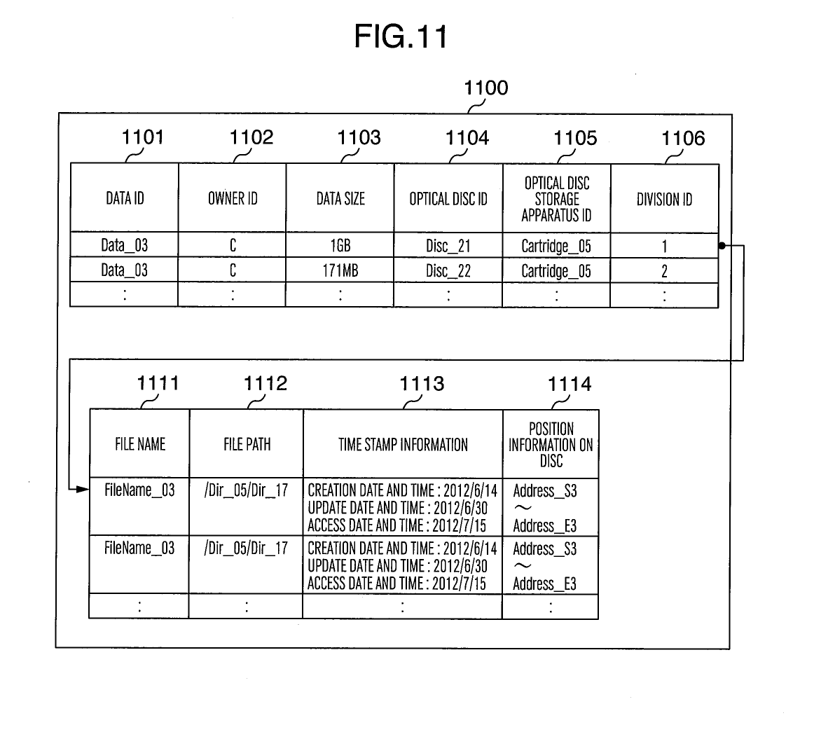

FIG. 11 is a diagram illustrating one example of a file table, and shows a state where file data of a file name of FileName 03 is divided into at least two of 1 GB and 171 MB and assigned to be recorded in optical disc IDs of disc 21 and disc 22 respectively. Here, all of divided information is actually recorded in parts omitted in the figure. In others of the Embodiment, it does not matter whether the unit of data is a block, file or a separately managed unit in the present invention, but, in FIG. 11, it is assumed that the unit of data is a file and the data is managed on a file system as a matter of convenience.

“1100” indicates a file table, which is a table that manages information on divided files of a database in which data ID 1101, owner ID 1102, data size 1103, optical disc ID 1104, optical disc storage apparatus ID 1105, division ID 1106, file name 1111, file path 1112, time stamp information 1113 and position information 1114 on are recorded.

“1101” indicates the data ID, which is a character string or numeral to identify data. The above-mentioned ID is attached when file data is stored in an archive system. It can be attached in any method as long as it is unique to the data, but, for example, if it is information with less capacity such as only a numeral, processing related to the file table 1100 becomes light, and is convenient.

“1102” is owner ID, which is an ID showing the owner of a file of the same row. When the above-mentioned file data is stored in a data library system, the user ID (UID) or the like of the user who stores the file data in the system is recorded. Instead of the above-mentioned user, the UID designated by the user may be recorded.

“1103” indicates the data size, where the capacity of divided file data of division ID 1106 in the same row of file data of the same row is recorded. “1104” indicates the optical disc ID, where the optical disc ID of optical disc 108 that records file data of the division ID shown by the same row is recorded. The optical disc ID is an ID to identify optical disc 108. “1105” indicates optical disc storage apparatus ID, where an ID to identify optical disc storage apparatus 107 in which the above-mentioned optical disc 108 is stored is recorded.

“1106” indicates the division ID, which is an ID to identify divided file data in the file data and is attached when file data of the same row is divided. The above-mentioned division ID is attached in order from the head of file data to understand what place from the head of the file data the divided data of the same row is.

There is no offset information in division file table 1100 in FIG. 11, but there may be given offset showing what byte from the head of file data the head of divided file data is. In a case where there is not the above-mentioned offset, the offset is calculated from data size 1103 and division ID 1106. For example, in divided file data of division ID 3, a result of adding the data sizes of division ID 1 and division ID 2 corresponds to the offset.

“1111” indicates the file name, where the file name of file data shown by the data ID of the same row is recorded. The file name is a character string or numeral in a format of a character code such as UTF-8. For example, the size of the character string of the above-mentioned file name 1111 is limited to 255 bytes.

The size of the character string has to be adjusted to the environment of other systems or terminal with which the data library system of this Embodiment is connected, and it may be greater than 255 bytes. However, in a case where the above-mentioned other systems and the above-mentioned terminal are in multiple environments in which the above-mentioned limitation is different, when file data in which the larger limited character string size exceeds the limitation of the smaller character string size of different limitation is stored in the data library system, since it is not possible to read the file data from the smaller character string size of different limitation, it may be limited to the same size as the one limited to the minimum size such that it can be read from anywhere.

“1112” indicates a file path, where a file path of file data of the same row on a file system shown outside the data library system is recorded. The above-mentioned file system is different from a file system on a recording medium, and a divided file shows a file to other systems or a terminal as file data before division.

In a case where divided file data is accessed from the outside of the data library system of this Embodiment, division file table 1100 is referred to, corresponding file data is searched using the file name and the file path as a key, all divided files of the corresponding file data is read, and, if there is a reproduction request from the head of the file data, data is read in order from divided file data of division ID 1. In a case where the above-mentioned reproduction request is not from the head and an offset value is designated, data is read in order from divided file data of the maximum division ID equal to or less than the offset value.

“1113” indicates time stamp information, where time stamp information included in information on file data received from the outside of the data library system of this Embodiment together with a recording request of the file data is recorded. For example, the above-mentioned time stamp information includes the final access time, the final correction time and the file creation time, and so on.

“1114” indicates position information on a disc, where position information on optical disc 108 in which divided file data of the same row is recorded is described. Since there is a file system on optical disc 108, it is possible to specify the corresponding divided file only by the file name and the file path. However, for example, in a case where it is not possible to read file data from the file system of optical disc 108 such as a case where there occurs a failure that the file system on optical disc 108 cannot be read or a case where there is a problem on performance, it is possible to read the corresponding file data by using position information on optical disc 108.

In step S703 in which recording in an optical disc is performed, in a case where each data capacity is sufficiently smaller than the capacity of optical disc 108 and multiple items of data are recorded in same optical disc 108, according to division file table 1100, the data library system records what has remaining capacity 1006 of disc table 1000 equal to or less than an arbitrary threshold or optical disc 108 with the number of data equal to or greater than an arbitrary threshold.

Division file table 1100 is recorded for divided file data, but one only for the number of optical discs subjected to division recording of data may be recorded to reduce the size of the table, and, in this case, information on the way of division is also recorded.

In the data library system of the above mode, when a recording task sleeps and other recording tasks are activated, the number of recording tasks that access hard disk 117 is limited, the continuity of an IO request for hard disk 117 improves, and it is possible to realize a data library system of good efficiency in which the transfer speed of data read from hard disk 117 is high.

### Embodiment 2

The present invention may adopt the mode of Embodiment 2. Embodiment 2 basically adopts all the same modes as Embodiment 1, but they are different in the following points. Hard disk 117 of Embodiment 2 is formed with one or more hard disk drives or a RAID group including multiple hard disk drives.

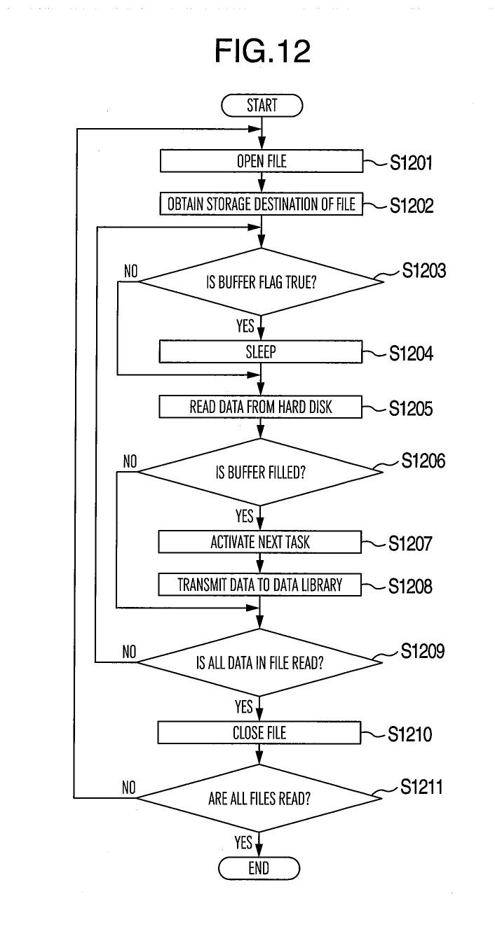

FIG. 12 is a detailed processing flow of processing S804 that records file data. S1202 indicates processing to obtain a file storage destination, where information on the hard disk drive or RAID group that is a storage destination of the current position of a file opened in S1201 is obtained and it proceeds to S1203.

S1203 indicates processing to determine whether a buffer flag is TRUE, where it proceeds to S1204 when the buffer flag on memory 302 is TRUE, and it proceeds to S1205 when it is FALSE. The buffer flag is set to TRUE in S1207 and set to FALSE in S1204.

S1204 indicates processing to sleep, where a recording task itself is slept to stop processing. As for the queue of each storage destination at that time, its own recording task ID is added to a queue corresponding to the storage destination obtained in S1202. Moreover, the above-mentioned buffer flag is set to FALSE at that time. Sleeping is not performed in a case where other recording tasks are not in the above-mentioned queue. It proceeds to S1206 after data is read from hard disk 117 in S1205, it is determined whether the above-mentioned buffer is filled, it proceeds to S1207 in a case where the buffer is filled, and it proceeds to S1209 in a case where the server is not filled.

S1207 indicates processing to activate the next task, where the next recording task of a queue corresponding to the storage destination obtained in S1202 is activated. At that time, the above-mentioned buffer flag is set to TRUE. In a case where there is no recording task in the queue, another recording task is not activated. It proceeds to S1209 after data is transmitted to data library apparatus 101 in S1208, it proceeds to S1210 in a case where all data is read in S1205 among data in the file opened in S1201, and it proceeds to S1203 in a case where there is the remaining data capacity which is not read in S1205.

After the file opened in S1203 is closed in S1210, it proceeds to S1211 to determine whether all files are read, the processing ends in a case where all files have been read, and it returns to S1201 in a case where a file that has not been read yet remains.

In the data library system of the above-mentioned mode, when a recording task sleeps and other recording tasks are activated, the number of recording tasks that perform accessing in a unit of the above-mentioned hard disk drive or RAID group is limited, the continuity of an IO request for hard disk 117 improves for each hard disk drive or RAID group, accessing becomes possible in parallel for each hard disk drive or RAID group, and it is possible to realize a data library system with good efficiency in which the transfer speed of data read from hard disk 117 is high.

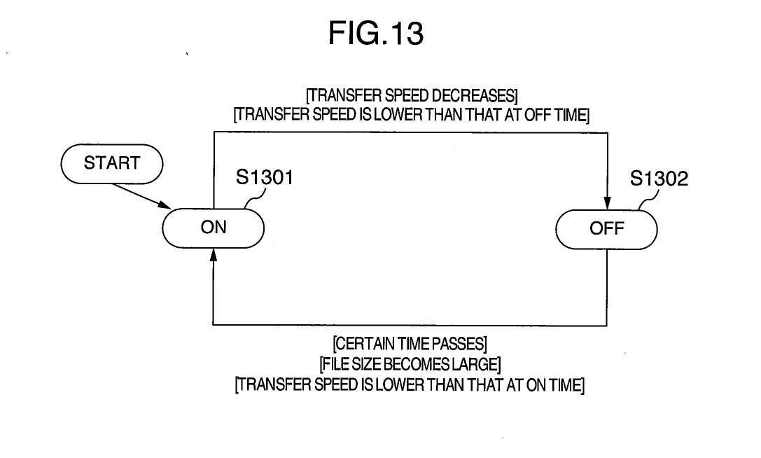

FIG. 13 is a diagram illustrating the transition between a state where the number of the above-mentioned recording tasks is limited (this state is assumed to be ON) and a state where it is not limited (this state is assumed to be OFF). In this Embodiment, there are two states of the ON state to implement processing to sleep in S907 and S1204 and activate the next task in S905 and S1207 and the OFF state not to implement them, and a management task that manages these states is operated on server 115.

The above-mentioned states are preserved in a sleep flag in memory 302 of server 115, the sleep flag is set to TRUE at ON time, and the sleep flag is set to FALSE at OFF time.

When the data library system of this Embodiment begins to operate, the state is set to ON. The transfer speed of a hard disk is monitored at regular intervals in the ON state, and a state where it becomes a lower transfer speed than a state switching threshold is assumed to be OFF. The above-mentioned threshold adopts a value preset by the system of this Embodiment or a value obtained as a result of calibration performed during introduction operation or the like when the system of this Embodiment is installed. As for the above-mentioned calibration, server 115 reads data from hard disk 117 and calculates the transfer speed of the hard disk, and constant multiplication of the measured transfer speed is assumed as the above-mentioned threshold. The above-mentioned constant is a numeral greater than 0 and less than 1.

Moreover, the state is set to OFF in a case where the current transfer speed is lower than the previous transfer speed in the OFF state immediately after it is switched to the ON state.

In the OFF state, the time after the OFF state and the average value of the sizes of files read from hard disk 117 by a recording task are monitored at regular intervals. As for the OFF state, in a case where a constant time has passed since the OFF state, the state is set to ON.

Moreover, as for the OFF state, in a case where the average value of file sizes becomes larger than a threshold that is a constant value set in advance in a system, the state is set to ON.

Moreover, in a case where the current transfer speed is lower than the previous transfer speed in the ON state immediately after it is switched to the OFF state, the state is set to ON.

### Embodiment 3

The present invention may adopt the mode of Embodiment 3. Embodiment 3 basically adopts all the same modes as Embodiment 1, but they are different in the following points.

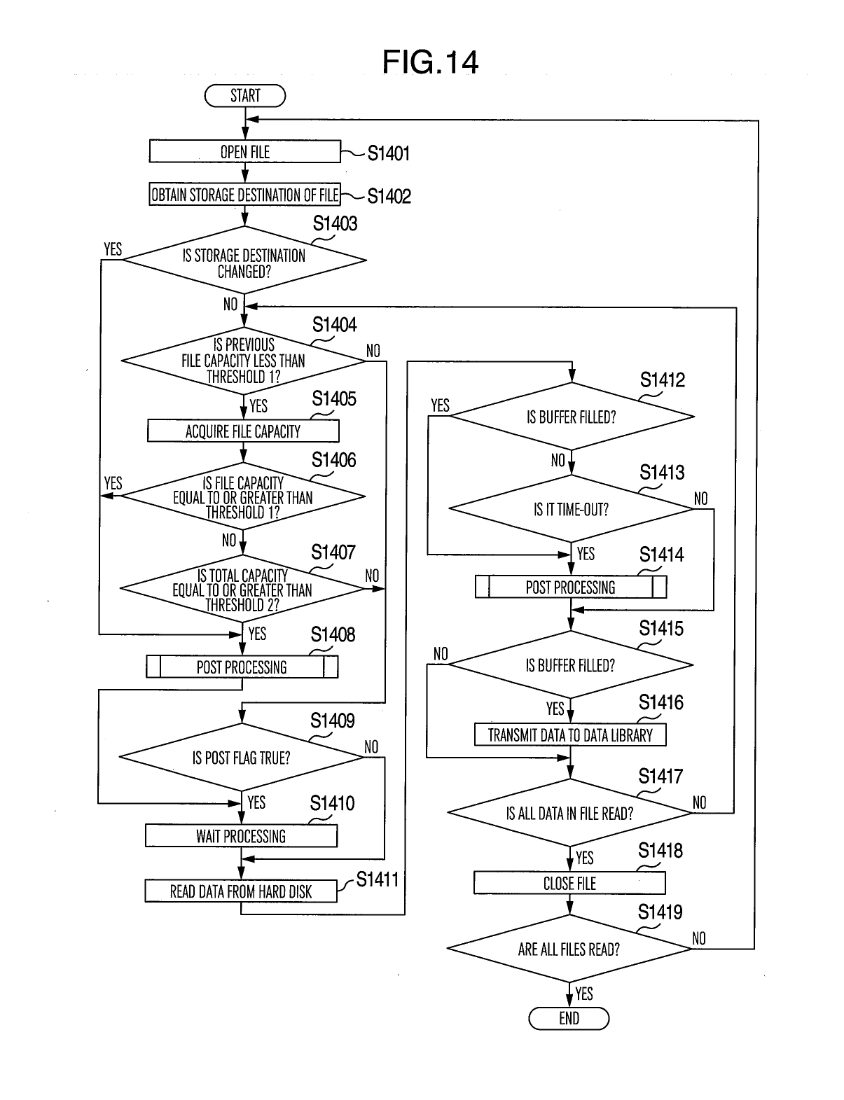

FIG. 14 is a detailed processing flow of processing S804 to record file data in Embodiment 3 instead of FIG. 9 in Embodiment 1. In the flow of FIG. 14, it differs from FIG. 9 in switching post processing S1408 and S1414 to switch processing according to file capacity, wait processing S1410 and the switching of processing according to a storage destination, and so on.

S1403 indicates processing to determine whether a storage destination has changed, by the storage destination information acquired in S1402, where it proceeds to S1408 if the file storage destination has changed and it proceeds to S1404 if it has not changed.

The above-mentioned storage destination shows any of a logical volume formed on hard disk 117. For example, hard disk 117 include ten hard disk drives, forms a RAID group every five hard disks in RAMS, include two RAID groups, creates a logical unit for each of the RAID groups and creates a logical volume by performing format in a file system for each of the logical units. In a case where a file is stored on the logical volume, the storage destination shows any of the logical volume.

S1404 indicates processing to determine whether the previous file capacity is less than a threshold, where it proceeds to S1405 if the capacity of a file opened before a file previously opened in S1401 is smaller than threshold 1 defined in advance in the system, and it proceeds to S1409 if it is equal to or greater than threshold 1. It is assumed that it proceeds to S1409 if they are equal, but it may be defined to proceed to S1405. For example, above-mentioned threshold 1 is set to 10 MB.

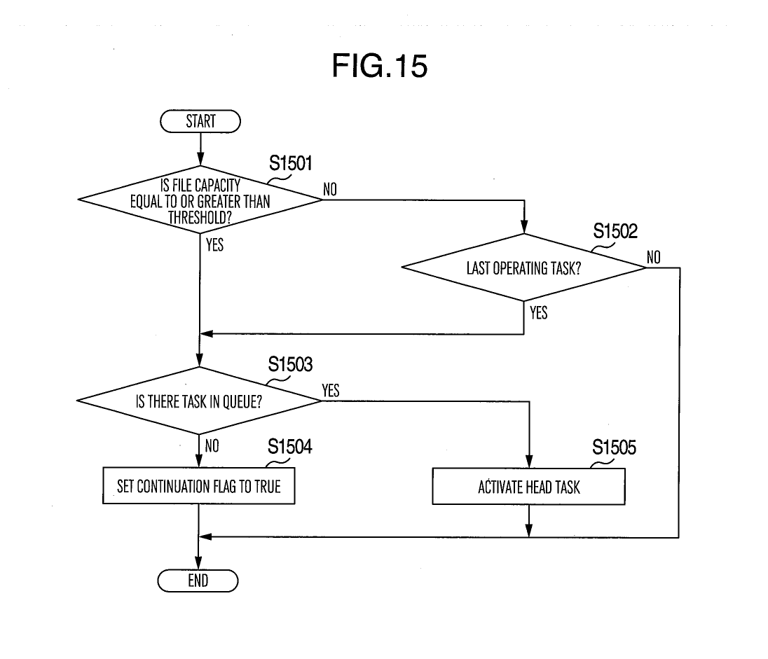

S1409 indicates processing to determine whether a post flag is TRUE, where it proceeds to S1410 in the case of TRUE and proceeds to S1411 in the case of FALSE. The above-mentioned post flag is set to TRUE when the determination processing in S1503 in FIG. 15 is performed and it is set to FALSE when the determination processing in S1409 is performed. The above-mentioned post flag holds the value in each task, and the values of respective tasks are not synchronized.

S1405 indicates processing to acquire file capacity, which is processing to acquire the capacity of the file opened in S1401. For example, in a case where a task operates on Linus (registered trademark), the file capacity is acquired from a file system by STAT processing or the like.

S1406 indicates processing to determine whether the file capacity is equal to or greater than a threshold, where it proceeds to S1408 if it is equal to or greater than above-mentioned threshold 1 and it proceeds to S1405 if it is less than above-mentioned threshold 1. It is assumed that it proceeds to S1408 if it is equal to above-mentioned threshold 1, but it may be defined to proceed to S1407.

S1407 indicates processing to determine whether the total capacity is equal to or greater than a threshold, where it proceeds to Sl408 if the total capacity that is the variable of each above-mentioned storage destination to which the file capacity acquired in above-mentioned S1405 is added is equal to or greater than threshold 2, and it proceeds to S1409 if it is less than threshold 2. It is assumed that it proceeds to S1408 if it is equal to threshold 2 in the above, but it may proceed to S1409.

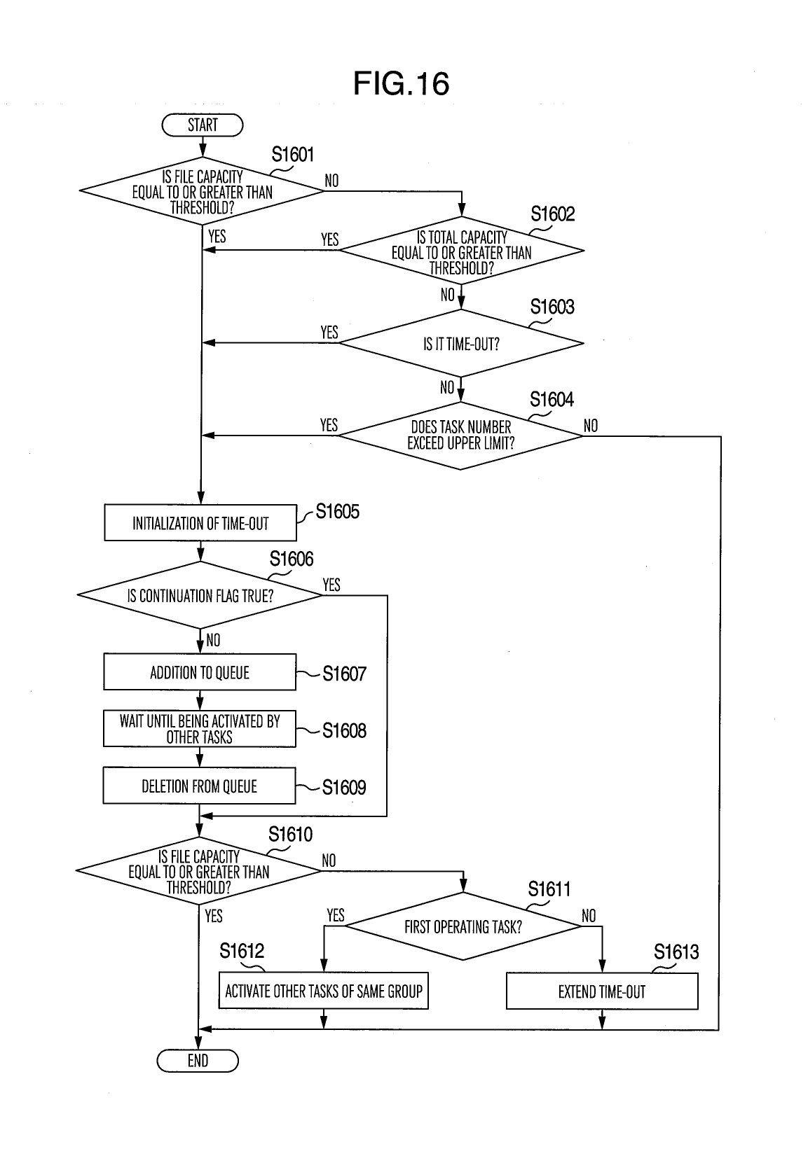

The above-mentioned total capacity is initialized when time-out initialization S1605 in FIG. 16 is performed by wait processing S1410. It proceeds to S1410 after post processing to activate the next task is performed in S1408. It proceeds to S1411 after wait processing is performed in S1410. It proceeds to S1412 after server 115 reads the file data opened in S1401 from hard disk 117 in S1411, it is determined whether the above-mentioned buffer on server 115 is filled, it proceeds to S1414 if the buffer is filled, and it proceeds to S1413 if the buffer is not filled. S1413 indicates to processing to determine whether it is time-out, where it proceeds to S1414 if the current time is equal to or after the time-out time which is the variable of each above-mentioned storage destination, it proceeds to S1415 if it is before the time-out time, it is determined whether the above-mentioned buffer on server 115 is filled, it proceeds to S1416 if the buffer is filled, and it proceeds to S1417 if the buffer is not filled. It is assumed to proceed to S1414 if the current time is equal to the above-mentioned time-out time in the above, but it may be defined to proceed to S1415.

In S1417, it proceeds to S1418 if all data is read in S1411 among data in the file opened in S1401, and it proceeds to S1404 if there is the remaining data capacity which is not read in S1411.

After the file opened in S1401 is closed in S1418, it proceeds to S1419 to determine whether all files are read, the processing ends if all files have been read, and it returns to S1401 if a file that has not been read yet remains.

The above-mentioned time-out time may be set to about a time period during which one task performs the reading processing in S1411 on files continuously stored in one or more places on the above-mentioned logical volume, and, for example, it is equal to or greater than 100 milliseconds in a case where the continuous reading performance of the above-mentioned logical volume is expected to be about 1 GB/s when a file of 100 MB continuously stored in places on the above-mentioned logical volume by the processing in S1411 is read. The above-mentioned time-out extension time may be set in the same way as above, and, for example, it is equal to or greater than 100 milliseconds.

By setting each time as above, the file capacity is smaller than constant capacity which is read in S1411 and set in advance, and, by the time it enters S1608 processing in FIG. 16 to wait until it is activated by other threads in the wait processing S1410 after it is activated by other tasks in wait processing S1410, in a case where it passes up to a time-out time or later, a task that performs the processing in S1411 several times performs the post processing in S1414 to activate other tasks.

By activating other tasks after it passes the above-mentioned time-out time, a partial task enters, for example, a state where it reads data randomly disposed in the above-mentioned logical volume, and, even if it performs reading with continuous reading performance slower than the above-mentioned reading performance, it is possible to equally give a processing chance of 1411 to respective tasks without a large influence on the waiting time of other tasks and keep the BD recording processing performance of the entire system.

By setting each time as above, in a case where the file capacity is larger than the constant capacity which is read in S1411 and set in advance and S1411 is processed with performance assumed in continuous reading with respect to the above-mentioned logical volume, the reading processing of the constant capacity is completed and there is no influence by the time-out determination in S1413.

The above-mentioned time-out time and the above-mentioned time-out extension time may not be equal, and, for example, in a case where there are many tasks that open a file less than above-mentioned threshold 1, it preferentially uses time for processing of a task that opens a file equal to or greater than above-mentioned threshold 1, and, in a case where processing is wanted to be performed, it only has to set the above-mentioned time-out extension time to be shorter than the above-mentioned time-out time.

The time-out processing has been performed according to the flow illustrated in FIG. 14 in the above, but, when a task that monitors the current time with respect to the time-out time is installed and the monitoring task passes the time-out time, processing of a task that currently processes S1411 among tasks that process the flow of FIG. 14 may be interrupted to proceed to S1414. By the above-mentioned change, even in a case where it takes time for the processing in S1411, it is possible to suppress an influence on the waiting time of other tasks and improve the BD recording processing performance of the entire above-mentioned system. FIG. 15 illustrates the flow of the post processing in S1408 and S1414 in FIG. 14.

S1501 indicates processing to determine whether file capacity is equal to or greater than a threshold, where it proceeds to S1503 if the capacity of the file opened in S1401 is equal to or greater than above-mentioned threshold 1 and it proceeds to S1502 if it is less than above-mentioned threshold 1. It is assumed to proceed to S1503 if it is equal to above-mentioned threshold 1, but it may be defined to proceed to S1502.

S1502 indicates processing to determine the last operating task, where it proceeds to S1503 if there are no other tasks than a task that waits for the processing in S1608 to wait until it is activated by other tasks in wait processing 1407 among tasks that open a file of the above-mentioned same storage destination, and the processing ends if there are other tasks.

S1503 indicates processing to determine whether there is a task in a queue, where it proceeds to S1505 if there is a task in the queue and it proceeds to S1504 if there is no task.

There is the above-mentioned queue for each above-mentioned storage destination, and an identifier to identify a task in a unit of the above-mentioned task and information by which it is possible to determine whether the capacity of data opened by a task is equal to or less than above-mentioned threshold 1 are stored in the queue as data. The above-mentioned identifier is, for example, a thread ID. It is sufficient if it is possible to perform the determination processing of above-mentioned information S1503, for example, it is file capacity or a flag set to be TRUE in a case where the file capacity is equal to or greater than threshold 1.

S1504 indicates processing to set a continuation flag to TRUE, where TRUE is substituted for a continuation flag of a variable that holds the value of each above-mentioned storage destination.

S1505 indicates processing to activate the head task, where the head task of the above-mentioned queue is activated. The above-mentioned head task denotes a task inserted in the queue at the earliest time among tasks in the above-mentioned queue.

FIG. 16 illustrates the flow of the wait processing in S1407. S1601 indicates processing to determine whether file capacity is equal to or greater than a threshold, where it proceeds to S1605 if the above-mentioned file capacity is equal to or greater than above-mentioned threshold 1 and it proceeds to S1602 if it is less than above-mentioned threshold 1. It may be defined to proceed to S1602 if they are equal.

S1602 indicates processing to determine whether the total capacity is equal to or greater than a threshold, where it proceeds to S1605 if the above-mentioned total capacity is equal to or greater than above-mentioned threshold 2 and it proceeds to S1603 if it is less than above-mentioned threshold 2. It may proceed to S1603 if they are equal.

S1603 indicates processing to determine whether it is time-out, where it proceeds to S1605 if the current time is after the above-mentioned time-out time and it proceeds to S1604 if it is before the above-mentioned time-out time.

S1604 indicates processing to determine whether the number of tasks exceeds the upper limit, where it proceeds to S1605 if the number of simultaneously operating tasks is equal to or greater than threshold 3 that is the task number in which tasks that open a file of file capacity equal to or less than above-mentioned threshold 1 of the same storage destination can simultaneously operate, and the processing ends if it is less than threshold 3.

By the processing in S1601, S1602, S1603 and S1604, in a case where a task with the above-mentioned file capacity less than the threshold operates, a task of the same storage destination can continue processing if the above-mentioned total capacity, the current time with respect to the time-out time and the number of currently operating tasks are within a certain range, and a certain processable period is secured for a task that opens a file with small file capacity within a range in which a task that opens a file of large file capacity is less affected, and it is possible to prevent a series of processing completion of the task from slowing.

S1605 indicates processing to perform time-out processing, where the above-mentioned time-out time is set to the time after the current time by the above-mentioned time-out time. The above-mentioned processing simultaneously performs initialization of the above-mentioned total capacity and initialization of the number of simultaneously operating tasks. In the initialization of the above-mentioned total capacity, the capacity of a file opened by the subject task is substituted for the above-mentioned total capacity. In the initialization of the above-mentioned number of simultaneously operating tasks, 1l is substituted for the above-mentioned number of tasks.

S1606 indicates processing to determine whether a continuation flag is TRUE, where it proceeds to S1610 if the above-mentioned continuation flag is TRUE and it proceeds to S1607 if it is not TRUE.

S1607 indicates processing to perform addition to a queue, where data including the above-mentioned identifier of the subject task and the above-mentioned information is inserted in the end of the above-mentioned queue.

In S1608, the subject task sleeps and waits until it is activated by other tasks. Specifically, it is processing to activate tasks in the above-mentioned queue in order from the head and wait until the subject task is activated.

Processing S1505 to activate the head task, processing S1608 to wait until it is activated by other tasks, and processing S1612 to activate other tasks of the same group are performed, and, by switching an operating task to the task activated in S1505 and a task of the same group as the activated task among tasks that have operated until S1505 and other tasks of the same group as the tasks that has operated, the number of tasks that concurrently perform processing S1411 to read data from a hard disk is limited according to file capacity. S1609 indicates processing to perform deletion from a queue, which is processing to delete information on the subject task from a queue. By the above-mentioned processing in S1504, S1505, S1606, S1607, S1608 and S1609, tasks that open files of the same storage destination perform processing to read data from the hard disk in S1411 one by one in a case where the file capacity is equal to or greater than threshold 1, it is performed by the number of tasks equal to or less than threshold 3 in a case where it is less than threshold 1, and it is possible to efficiently perform reading from hard disk 117.

S1610 indicates processing to determine whether the file capacity is equal to or greater than a threshold, where it proceeds to S1611 if the above-mentioned file capacity is equal to or greater than above-mentioned threshold 1, and the processing ends if it is less than above-mentioned threshold 1.

S1611 indicates processing to determine the first operating task, where a task that performed S1606 processing last among tasks that opened a file of the same storage destination proceeds to S1612 and other tasks than the task proceed to S1613.

S1612 indicates processing to activate other tasks of the same group, where the group is a group to which all tasks with the above-mentioned file capacity less than above-mentioned threshold 1 in the above-mentioned queue of the above-mentioned same storage destination belong, and the tasks belonging to the group are activated in order from the one whose insertion time of the above-mentioned queue is earlier.

In the above-mentioned activation processing, 1 is added to the above-mentioned number of simultaneously operating tasks before one of the above-mentioned other tasks is activated, the capacity of a file opened by the activated task is added to the above-mentioned total capacity, and, in a case where the above-mentioned number of simultaneously operating tasks exceeds above-mentioned threshold 3 or the above-mentioned total capacity exceeds threshold 2, the above-mentioned number of simultaneously operating tasks and the above-mentioned total capacity are returned to a value before the above-mentioned addition, and the processing in S1612 ends.

S1613 indicates processing to extend time-out, where the above-mentioned time-out time is updated to time later by the above-mentioned time-out extension time. However, in a case where the time-out time is a time after the time later than the current time by the time-out extension upper limit time, the time-out time is set to a time later than the current time by the time-out extension upper limit time.

By the operation of above Embodiment 3, even if there is a task that opens a file with file capacity less than threshold 1, it is possible to suppress influence given to a series of processing time of a task that opens a file with file capacity larger than threshold 1, and it is possible to efficiently read data from hard disk 117.

The present invention is not limited to the above-mentioned Embodiments and includes various transformation Embodiments. For example, the above-mentioned Embodiments give detailed explanation to describe the present invention plainly, and it is not necessarily limited to the one including all described configurations. Moreover, it is possible to replace part of the configuration of a certain Embodiment with the configuration of other Embodiments, and it is also possible to add the configuration of other Embodiments to the configuration of a certain Embodiment. Moreover, it is possible to add, delete or replace other configurations for part of the configuration of each Embodiment.

Moreover, part or all of above-mentioned each configuration, function, processing unit and processing means, and so on, may be realized by hardware by designing them by an integrated circuit, for example. Moreover, above-mentioned each configuration and function, and so on, may be realized by software by interpreting and executing a program that realizes each function by a processor. Information on programs, tables and files that realize each function can be stored in recording apparatuses such as a memory, a hard disk and an SSD (Solid State Drive) or recording media such as an IC card, an SD card and a DVD. Moreover, control lines and information lines which are considered to be necessary for explanation are shown, and all control lines and information lines are not necessarily shown on a product. It may be actually considered that almost all configurations are mutually connected.

1. A data library system which performs recording and reproduction of data, comprising:
a first recording apparatus which stores data;
a second recording apparatus including multiple recording media; and
a controller which controls recording and reproduction of data to the recording media and data transfer between the first recording apparatus and the second recording apparatus,
wherein the controller performs control such that a data transfer task which corresponds to each of the recording media and transfers data from the first recording apparatus to the second recording apparatus operates on the controller, and limits the number of the data transfer tasks operating in parallel when the data stored in the first recording apparatus is transferred to the second recording apparatus.

2. The data library system according to claim 1,
wherein the controller limits the number of the operating data transfer tasks to one.

3. The data library system according to claim 1,
wherein the controller manages a logical volume which is a storage area provided by the first recording apparatus, as a data storage destination, and limits the number of the operating data transfer tasks for each of the logical volumes.

4. The data library system according to claim 1,
wherein the controller limits the number of the operating data transfer tasks to one when the data stored in the first recording apparatus is the data transfer task that treats data of a predetermined size or more, and does not limit the number of the operating data transfer tasks when the data stored in the first recording apparatus is the data transfer task that treats data of the predetermined size or less.

5. The data library system according to claim 1,
wherein the controller switches operation of the data transfer task different from the operating data transfer task on a condition that a predetermined time period during which the operating data transfer task operates on the controller or more passes.

6. The data library system according to claim 1, ,
wherein the controller switches operation of the data transfer task different from the operating data transfer task on a condition that a total of capacity of a storage destination of data corresponding to the operating data transfer task and capacity of data treated by the operating data transfer task is equal to or greater than a predetermined capacity.

7. The data library system according to claim 1, wherein:
a first data transfer task that operates on the controller and transfers data of the predetermined size or more and multiple second data transfer tasks that transfer data of the predetermined size or less are included; and
the second data transfer task operates on the controller, and the controller switches operation of the first data transfer task that is not operating, on a condition that a total of capacity of storage destinations of data treated by the operating second data transfer task and data corresponding to the second data transfer task is equal to or greater than a predetermined capacity.
